(19) United States
(12) Patent Application Publication
(10) Pub. No.: US 2018/0002023 A1
(43) Pub. Date: Jan. 4, 2018

(54) Cooling system for unmanned aerial vehicle

(71) Applicant: Yuneec International (China) Co.,Ltd, Kunshan (CN)

(72) Inventors: Yu Tian, Kunshan (CN); Wenyan Jiang, Kunshan (CN)

(73) Assignee: Yuneec International (China) Co.,Ltd

(21) Appl. No.: 15/703,988

(22) Filed: Sep. 14, 2017

(30) Foreign Application Priority Data
Dec. 27, 2016 (CN) 201611230997.5
Dec. 27, 2016 (CN) 201621449383.1
Dec. 27, 2016 (CN) 201621449454.8

(51) Int. Cl. B64D 13/00; F01P 5/02; B64C 39/02; F01P 1/06

(52) U.S. Cl. CPC B64D 13/006; F01P 1/06; F01P 5/02; B64C 39/024; B64C 2201/042; B64C 2201/108; F01P 2050/20; B64C 2201/165

(57) ABSTRACT

The present invention disclosed a cooling system for unmanned aerial vehicle, which includes a main body, four arms disposed on the main body, two clockwise rotating propellers and two counterclockwise rotating propellers disposed on the arms respectively; wherein at least one air guide hole on each of the arms, which guide air to a middle of the main body; the two clockwise rotating propellers are disposed diagonally and the two counterclockwise rotating propellers are disposed diagonally; a clockwise rotating propeller is on a left-front arm; each of the clockwise and the counterclockwise rotating propellers rotates to generate an airstream which is configured to sweep towards the arm, the airstreams are configured to flow to an internal part of the main body by the air guide hole. The cooling system is able to cool down the whole unmanned aerial vehicle.

### CROSS REFERENCE OF RELATED APPLICATION

The present invention claims priority under 35 U.S.C. 119(a-d) to CN 201621449454.8, filed Dec. 27, 2016; CN 201621449383.1, filed Dec. 27, 2016; and CN 201611230997.5, filed Dec. 27, 2016.

### BACKGROUND OF THE PRESENT INVENTION

### Field of Invention

The present invention relates to the unmanned aerial vehicle field, and more particularly to a cooling system for unmanned aerial vehicle.

### Description of Related Arts

An unmanned aerial vehicle is a vehicle without a person on board, which is operated by the radio remote control apparatus and on-board preset control devices. Heat is generated and accumulates while the unmanned aerial vehicle is working. If not being timely cooling down, the heat affects the normal operation of the unmanned aerial vehicle. Prolonged overheating damages the unmanned aerial vehicle or compromises the service life of the unmanned aerial vehicle. Conventionally, a cooling part is disposed on the unmanned aerial vehicle.

Conventionally, cooling air guide components are adopted to cool down the heat for an unmanned aerial vehicle, which assist the cooling of certain parts of the vehicle. For example, an airstream is guided into the battery box and then released to cool down the battery box. Other components of the unmanned aerial vehicle, such as the motor and the chip, also generate a large amount of heat. The conventional cooling air guide components are not able to guarantee the cooling effect.

Besides, the air guide holes are not able to collect the air sufficiently to cool down the vehicle due to the disposed position and structure of the air guide holes. Fans are required to be disposed inside the unmanned aerial vehicle to assist the air flow in cooling down the heat. The space inside the unmanned aerial vehicle is limited, to dispose a fan in which requires enlarging the main body of the unmanned aerial vehicle and increases the weight of the vehicle. Furthermore, the fans generate considerable noise while working.

### SUMMARY OF THE PRESENT INVENTION

An object of the present invention is to provide a cooling system for unmanned aerial vehicle, which is able to cool down the whole vehicle.

In order to overcome the problems of the conventional technology, the present invention provides a cooling system for unmanned aerial vehicle, which comprises a main body, four arms disposed on the main body, two clockwise rotating propellers and two counterclockwise rotating propellers disposed on the arms respectively; wherein at least one air guide hole on each of the arms, which guide air to a middle of the main body; the two clockwise rotating propellers are disposed diagonally and the two counterclockwise rotating propellers are disposed diagonally; a propeller on a left-front arm is a clockwise rotating propeller; each of the clockwise and the counterclockwise rotating propellers rotates to generate an airstream which is configured to sweep towards the arm, the airstreams are configured to flow to an internal part of the main body by the air guide hole.

The tangential rotating direction of the propeller at the point right above the arm is vertical to the long side of the arm. The airstream sweeps down the arm and is collected by the rectangle air guide holes disposed along the long side of the arm. The air guide holes guide the collected airstream into the inner side of the arm and ensure the collection of large portion of the airstream. The tails of the propellers generates the strongest airstream. The air guide holes are disposed right under the swept area by tails of the propellers, which ensures the maximum collection of the airstream and strongest air flow inside the main body. The air guide holes are disposed near the main body to minimum the airstream flow along the inner side of the arm and reduce the airstream loss.

The present invention provides an air guide structure for the unmanned aerial vehicle, which comprises arms, propellers disposed on the arms, at least one air guide hole disposed on the arms; wherein the air guide hole on each of the arms is disposed near a main body and under an area formed by a tail of the propeller.

The present invention provides a cooling air path system for an unmanned aerial vehicle, comprising an airstream source, air guide holes, an air path and an air vent; wherein the airstream source is generated by a rotation of propellers on arms; the air guide holes are disposed on a top of each of the arm and under an area formed by a corresponding propeller; the air path is space between an inner wall of a main body and an internal module inside the main body; the air vent is disposed on a bottom of the main body, which corresponds to a heat source area; an airstream is guided through the air guide hole to an inner side of each of the arms, enters the air path, passes the heat source area and is released through the air vent.

According to an embodiment of the present invention, each of the air guide holes is in a rectangle shape, the long side of which is along a long side of the arm on which the guide hole is disposed.

According to an embodiment of the present invention, a guiding wall is integrally molded on one long side of each of the air guide hole; the guiding walls of the air guide holes on the same arm guide the air toward a same direction; the guiding walls of the air guide holes on the arms of a same side of main body or diagonally opposite to each other are opposite, which guide the air to the internal of the main body.

According to an embodiment of the present invention, the guiding wall is integrally molded on a first long side of the corresponding air guide hole, which bends or tilts toward an inner side of the arm from the first long side; the first long side of the air guide hole is a far side toward the other arm on the same side of the main body.

According to an embodiment of the present invention, a length of each of the arms is equal or slightly longer than a single blade of the propellers.

According to an embodiment of the present invention, three air guide holes are disposed on the arm; the air guide holes are distributed on an interval along a short side of the arm and on a top of a middle of the short side of the arm.

According to an embodiment of the present invention, reinforce plates are disposed on an inner side of the arm, wherein the inner side faces wind.

According to an embodiment, the present invention comprises a main body which connects the arms; wherein an airstream collected by the air guide hole is guided into the main body.

According to an embodiment of the present invention, the main body and the arms are integrally molded; a top part of the main body indents a certain distance at a transitional connection part of the main body and the arms.

According to an embodiment of the present invention, the airstream collected by the air guide hole enters the main body along an inner wall of the main body and circulates within a whole inner cavity of the main body.

According to an embodiment, the present invention comprises a radiator which is disposed inside the main body and above the air vent; wherein the airstream passes the heat source area and the radiator in sequence before being released through the air vent.

According to an embodiment of the present invention, the internal module is a PCB (printed circuit board) module; electronic modules inside the unmanned aerial vehicle are mounted on the PCB module; the radiator is mounted on a back of the heat source area on the PCB module.

According to an embodiment of the present invention, four arms are disposed on the main body, on which propellers are disposed; the diagonally distributed propellers are rotating in a same direction; wherein the propellers on a left right arm and a right back arm are clockwise rotating propellers; the propellers on a right front arm and a left back arm are counterclockwise rotating propellers; an airstream generated by a rotation of the propellers sweeps to the arms and flows into the internal of the main body under the guidance of the air guide holes.

According to an embodiment of the present invention, at least one air guide hole is disposed on each of the arms; the air guide holes on each of the arms guides the air toward a middle of the main body; the airstream enters the main body, collides with the inner wall and the internal modules of the main body to form a fluctuating airflow.

According to an embodiment of the present invention, the main body comprises a top body shell, a bottom body shell and a bottom cover; wherein the air vent is disposed on the bottom cover; the top body shell and the bottom body shell are non-detachably connected; the bottom cover is detachable from the bottom body shell and forms a cavity with the air vent.

The benefits of the present invention compared with the conventional technology are as follows.

The middle part of the main body contains chips and components, on which heat is collectively accumulated. The air guide holes on the arms are disposed toward the middle part of the main body. The rotating direction of the propellers assists the air guide holes in collecting large portions of airstream and sweeping the airstream to carry away the accumulated heat. The wind generated by the propellers is fully utilized for cooling and the cooling effect is significant. Convection takes place inside the whole main body due to the strong airstream sweeping a large area of the main body, which effectively cools down the vehicle and no need for cooling fans.

The tails of the propellers generates the strongest airstream. The air guide holes are disposed right under the swept area by tails of the propellers, which ensures the maximum collection of the airstream and strongest air flow inside the main body. The air guide holes are disposed near the main body to minimum the airstream flow along the inner side of the arm and reduce the airstream loss.

The tangential rotating direction of the propeller at the point right above the arm is vertical to the long side of the arm. The airstream sweeps down the arm and is collected by the rectangle air guide holes disposed along the long side of the arm. The air guide holes guide the collected airstream into the inner side of the arm and ensure the collection of large portion of the airstream.

Strong airstream is generated while the propellers are rotating. Compared to the natural wind, the airstream generated by the propellers are more stable and strong, which is guided into the main body of the vehicle as an airstream source for cooling. The internal cooling fans are no longer needed if the airstream generated by the propellers is fully utilized.

The air path is formed by the space between the inner wall of the main body and the internal module. Specialized cabinet or other air path structures is not required, which reduce the weight and cost of the vehicle. The heat is carried away with the passing airstream and the whole main body is cooled down by the fluctuating airflow.

The air vent is disposed on the bottom of the main body, which enables maximum convection. Under the pressure of the internal airflow, the airstream carrying the heat is squeezed out of the main body. The air vent is disposed corresponds to the heat source area to carry away the heat more rapidly and improve the cooling effect.

The radiator is disposed on the heat source area, which absorbs the heat accumulated in the heat source area while operating. The heat generated by the chips and etc. is carried out precedently. The cooling area of the radiator is big and the heat is carried away rapidly by the passing airstream to realize high efficiency physical cooling.

### BRIEF DESCRIPTION OF THE DRAWINGS

FIG. 1 is a perspective view of a cooling system for an unmanned aerial vehicle according to a preferred embodiment of the present invention;

FIG. 2 is a sectional view of the cooling system for the unmanned aerial vehicle according to a preferred embodiment of the present invention;

FIG. 3 is an enlarged view of part of the cooling system for the unmanned aerial vehicle;

FIG. 4 is another sectional view of the cooling system for the unmanned aerial vehicle according to a preferred embodiment of the present invention;

FIG. 5 is a disassembled view of a bottom cover and the bottom body shell of the unmanned aerial vehicle.

Element numbers: 1-main body; 11-top body shell; 12-bottom body shell; 13-bottom cover; 2a, 2b, 2c, 2d-arm; 3a, 3c-clockwise rotating propellers; 3b, 3d-counterclockwise rotating propellers; 22a, 22b, 22c, 22d-air guide hole; 23a-guiding wall; 24a-reinforce plate; 131-air vent; 132-clip; 4-internal module; 5-radiator.

### DETAILED DESCRIPTION OF THE PREFERRED EMBODIMENT

Referring to the drawings, according to a preferred embodiment of the present invention, the object, characteristics and advantages of the present invention is clearly illustrated.

Specific details are described in the embodiments of the present invention for a better understanding. Other embodiments of the present invention are able to be conceived. One skilled in the art will understand that the embodiment of the present invention as shown in the drawings and described above is exemplary only and not intended to be limiting.

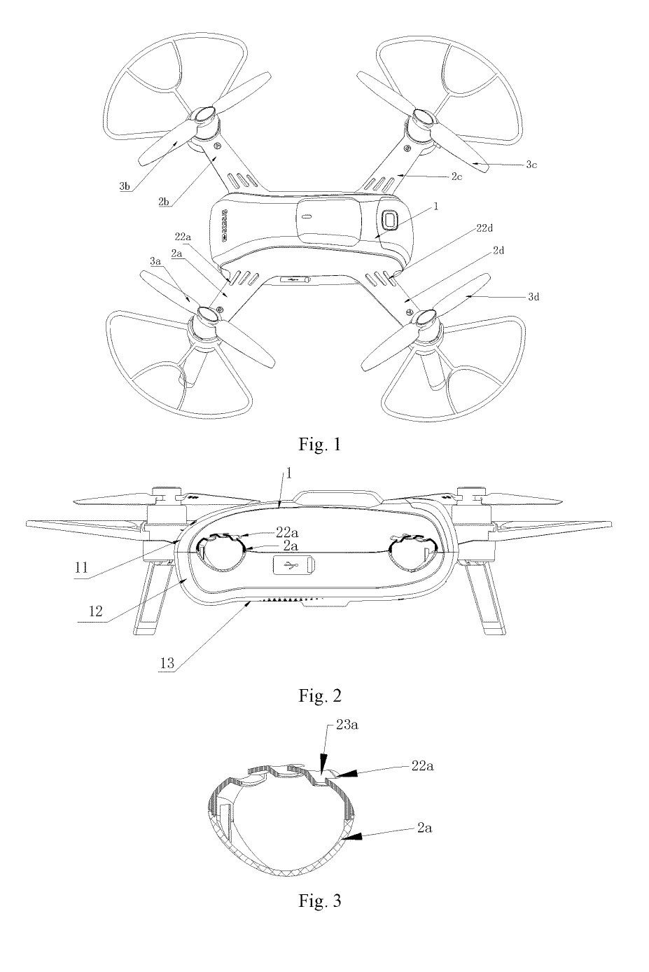

Referring to FIG. 1, according to an embodiment of the present invention, a cooling system for an unmanned aerial vehicle comprises main body 1, four arms 2a, 2b, 2c, and 2d disposed on the main body 1, two clockwise rotating propellers 3a and 3c and two counterclockwise rotating propellers 3b and 3d which are disposed on the arms respectively.

The propeller is driven by the motor to rotate. The rotating direction is controlled by a control circuit in a regular way which needs no particular explanation. The clockwise rotating propellers 3a and 3c rotates clockwise. The counterclockwise rotating propellers 3b and 3d rotates counterclockwise. The mounting method is not a limitation for the present invention. The propeller is able to be mounted on the arm by a propeller adapter and driven by the motor to rotate relative to the arm. The rotation of the propeller generates airstream.

At least one air guide hole is on each of the arms for collecting the airstream generated by the rotating propellers (the clockwise rotating propellers and the counterclockwise rotating propellers). The air guide holes 22a, 22b, 22c and 22d on the arms 2a, 2b, 2c and 2d guide the airstream toward a middle part of the main body 1. The collected airstream sweeps the middle part of the main body 1. Referring to the FIG. 1, the arm 2a is the left-front arm and the guiding direction of the air guide hole 22a is toward the right-back; the arm 2b is the right-front arm and the guiding direction of the air guide hole 22b is toward the left-back; the arm 2c is the right-back arm and the guiding direction of the air guide hole 22c is toward the left-front; the arm 2d is the left-back arm and the air guide hole 22d is toward the right-front. The diagonally distributed propellers rotate in the same direction. A clockwise rotating propeller is on the left-front arm, which is the two clockwise rotating propellers are on the arm 2a and 2c respectively and the two counterclockwise rotating propellers are on the arm 2b and 2d. The propeller rotates to generate the airstream which sweeps the corresponding arm. The settlement of the propellers and the guiding direction of the corresponding air guide holes enables the airstream generated by the rotation of the propellers (3a, 3c, 3b and 3d) to sweep toward the arm 2a, 2b, 2c and 2d and enter the main body 1 under the guidance of the air guide hole 22a, 22b, 22c and 22d.

The middle part of the main body 1 contains chips and components, on which heat is collectively accumulated. The air guide holes on the arms are disposed toward the middle part of the main body. The rotating direction of the propellers assists the air guide holes in collecting large portions of airstream and sweeping the airstream to carry away the accumulated heat. The wind generated by the propellers is fully utilized for cooling and the cooling effect is significant. Convection takes place inside the whole main body due to the strong airstream sweeping a large area of the main body, which effectively cools down the vehicle and no need for cooling fans.

The air guide hole on each of the arms is disposed near the main body 1 and under the area formed by the tail of the propeller on the arm. Taking arm 2a as an example, the air guide hole is disposed near the main body 1 and under the area formed by the tail of the clockwise rotating propeller 3a on the arm 2a. The tails of the propellers generates the strongest airstream. The air guide holes are disposed right under the swept area by tails of the propellers, which ensures the maximum collection of the airstream and strongest air flow inside the main body. The air guide holes are disposed near the main body to minimum the airstream flow along the inner side of the arm and reduce the airstream loss.

Each of the air guide holes is in a rectangle shape, the long side of which is along a long side of the arm on which the guide hole is disposed. The tangential rotating direction of the propeller at the point right above the arm is vertical to the long side of the arm. The airstream sweeps down the arm and is collected by the rectangle air guide holes disposed along the long side of the arm. The air guide holes guide the collected airstream into the inner side of the arm and ensure the collection of large portion of the airstream.

A guiding wall is disposed on each of the air guide hole. Referring to the FIG. 2 and FIG. 3, the guiding wall 23a is integrally molded on a first long side of the corresponding air guide hole 22a. The guiding walls of the air guide holes on the same arm guide the air toward a same direction; the guiding walls of the air guide holes on the arms of a same side of main body or diagonally opposite to each other are opposite, which guide the air to the internal of the main body. Referring to the FIG. 1, the guiding walls of the air guide holes on the arm 2a are opposite to the guiding walls of the air guide holes on the arm 2c or the guiding walls of the air guide holes on the arm 2d. In order to further stabilize the guiding wall, the guiding wall is connected to an adjacent side on the long side of the air guide hole through a transitional wall.

Take the arm 2a as an example to illustrate the deployment of the air guide holes, which is able to be adapted to other arms.

The guiding wall 23a is integrally molded on a first long side of the corresponding air guide hole 22a, which bends or tilts toward an inner side of the arm 2a from the first long side; the first long side of the air guide hole 22a is a far side toward the arm 2b (for the air guide hole on the arm 2b, the first long side is a far side toward the arm 2a). The collected airstream is smoothly guided into the main body 1 through the guiding wall 23a to avoid the airstream loss.

A length of each of the arms is equal or slightly longer than a single blade of the propellers. The blade is able to be mounted above the end of the arm. The propeller comprises two blades. A length of the arm 2a is equal or slightly longer than a single blade of the clockwise rotating propeller 3a. The position of the air guide hole 22a is further approaching to the main body 1 and at the same time under the area formed by the rotating clockwise rotating propeller 3a.

Three air guide holes are disposed on each of the arms; the air guide holes are distributed on an interval along a short side of the arm and on a top of a middle of the short side of the arm. Three air guide holes 22a are evenly distributed on an interval along a short side of the arm 2a and on a top of a middle of the short side of the arm. The strength of the structure is stronger at the area on which distributed the air guide holes and the airstream is able to be conveniently collected.

Reinforce plates are disposed on an inner side of the arm, wherein the inner side faces wind. The reinforce plate 24a is disposed on the side of the arm 2a facing the wind. The side facing the wind is opposite to the guiding wall 23a. The reinforce plates 24a is able to further strengthen the structure of the arm 2a.

The main body 1 and the arm 2a are integrally molded; a top part of the main body 1 indents a certain distance at a transitional connection part of the main body and the arms, which enables the tail of the propeller to further approach the main body without hitting the main body and the position of the air guide holes to further approach the main body.

The airstream collected by the air guide holes on each of the arms enters the main body along the inner side of the arm and is able to flow inside the whole main body. The airstream is not limited to a certain area, which is able to carry away the heat inside the whole main body and prevents the heat accumulated in a certain area of the main body being conducted to other part of the main body and compromising the cooling effect.

The main body comprises a top body shell 11, a bottom body shell 12 and a bottom cover 13. The bottom cover 13 is clipped on the bottom body shell 12. The top body shell 11 and the bottom body shell 12 are clipped together to form an internal cavity. The bottom cover 12 is detachable, which is convenient for the maintenance of the internal module inside the main body.

Referring to the FIG. 1 to FIG. 5, according to an embodiment of the present invention, the cooling air path system for an unmanned aerial vehicle comprises an airstream source, air guide holes, an air path and an air vent 131.

The airstream source is generated by the rotation of the propellers on each of the arms. The propeller is driven by the motor to rotate. The rotating direction is controlled by a control circuit in a regular way which needs no particular explanation. Strong airstream is generated while the propellers are rotating. Compared to the natural wind, the airstream generated by the propellers are more stable and strong, which is guided into the main body of the vehicle as an airstream source for cooling. The internal cooling fans are no longer needed if the airstream generated by the propellers is fully utilized.

The air guide holes are disposed on a top of each of the arm and under an area formed by a corresponding propeller, which collect the airstream from the airstream source efficiently. The tails of the propellers generates the strongest airstream. The air guide holes are disposed right under the swept area by tails of the propellers, which ensures the maximum collection of the airstream and strongest air flow inside the main body 1. The airstream generated by the propellers is fully utilized.

The air path is the space and passages between the inner wall of the main body 1 and the internal module 4. The airstream guided into the main body through the air guide hole flows along the air path. Convection takes place inside the air path. The air path is formed by the space between the inner wall of the main body 1 and the internal module 4. Specialized cabinet or other air path structures is not required, which reduce the weight and cost of the vehicle. The heat is carried away with the passing airstream and the whole main body 1 is cooled down by the fluctuating airflow.

The air vent 131 is disposed on a bottom of the main body 1, which corresponds to a heat source area; an airstream is guided through the air guide hole to an inner side of each of the arms, enters the air path, passes the heat source area and is released through the air vent 131. The airstream is able to flow along a certain path on the arm. The air vent 131 is disposed on the bottom of the main body 1, which enables maximum convection. Under the pressure of the internal airflow, the airstream carrying the heat is squeezed out of the main body 1. The air vent is disposed corresponds to the heat source area to carry away the heat more rapidly and improve the cooling effect.

Referring to the FIG. 5, according to an embodiment of the present invention, the cooling air path system for the unmanned aerial vehicle comprises a radiator 5 which is disposed inside the main body 1 and above the air vent 131; wherein the airstream passes the heat source area and the radiator 5 in sequence before being released through the air vent. The radiator 5 is disposed on the heat source area, which absorbs the heat accumulated in the heat source area while operating. The heat generated by the chips and etc. is carried out precedently. The cooling area of the radiator is big and the heat is carried away rapidly by the passing airstream to realize high efficiency physical cooling.

The radiator 5 is able to be distributed all over the cooling rib in a plate shape or cooling scales, which is not a limitation for the present invention. Other radiators with big cooling area are also adaptable.

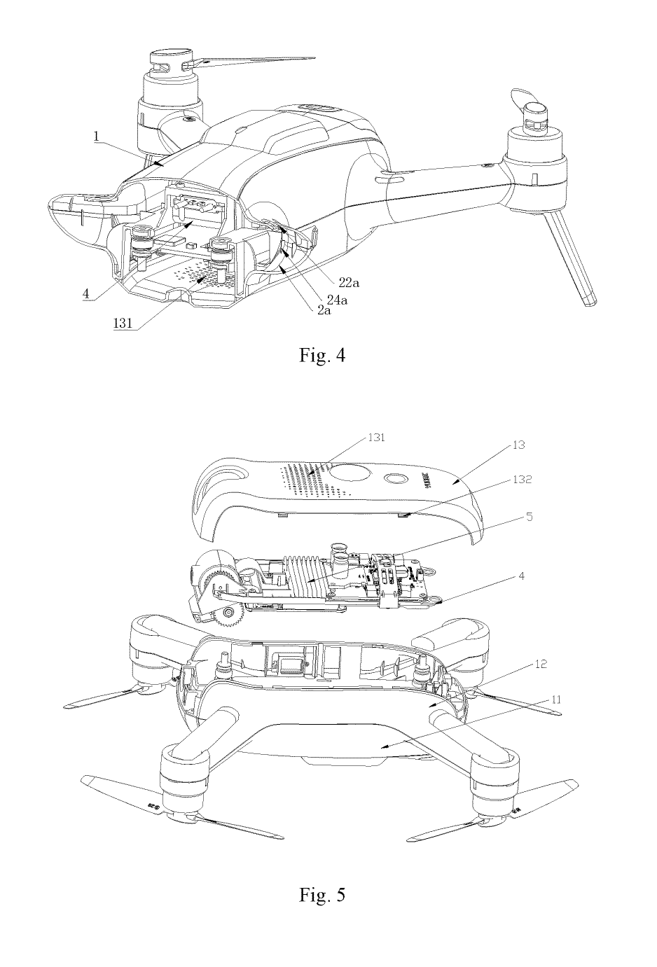

Referring to the FIG. 4 and FIG. 5, according to an embodiment of the present invention, the internal module 4 is a PCB (printed circuit board) module and electronic modules inside the unmanned aerial vehicle are mounted on the PCB module. The airstream is able to flow around the PCB module and carry away the heat generated by the electronic modules on the PCB module. The electronic modules are able to comprise a master control circuit, a power circuit, batteries, motors, an optical flow lens and etc. At the mean time, the radiator 5 is mounted on a back of the heat source area on the PCB module, which saves the space and enable radiator to be near to the heat source and the air vent. The heat conduction and cooling effect is thus improved.

The embodiments are not a limitation for the claims of the present invention. A skilled technician is capable of modifying the embodiments in the spirit and within the range of the present invention. The protection range is based on the claims of the present invention.

What is claimed is:

1. A cooling system for an unmanned aerial vehicle, comprising: a main body, four arms disposed on the main body, two clockwise rotating propellers and two counterclockwise rotating propellers disposed on the arms respectively; wherein at least one air guide hole is disposed on each of the arms, and configured to guide air to a middle part of the main body; the two clockwise rotating propellers are disposed diagonally and the two counterclockwise rotating propellers are disposed diagonally; one of the clockwise rotating propellers is on a left-front arm; each of the clockwise and the counterclockwise rotating propellers rotates to generate an airstream which is configured to sweep towards the arm, the airstreams are configured to flow to an internal part of the main body by the air guide hole.

2. The cooling system for the unmanned aerial vehicle, as recited in claim 1, wherein the air guide hole on each of the arms is disposed near the main body and under an area formed by the rotating of a tail of each of the clockwise rotating propellers and counterclockwise rotating propellers.

3. The cooling system for the unmanned aerial vehicle, as recited in claim 1, wherein the air guide hole is in a rectangle shape, a long side of which is along a long side of each of the arms on which the guide hole is disposed.

4. The cooling system for the unmanned aerial vehicle, as recited in claim 3, wherein a guiding wall is integrally molded on one long side of the air guide hole; the guiding wall of the air guide hole on the same arm guide the air toward a same direction; the guiding wall of the air guide hole on the arms of a same side of the main body or diagonally opposite to each other are opposite, which guide the air to the internal of the main body.

5. The cooling system for the unmanned aerial vehicle, as recited in claim 4, wherein the guiding wall is integrally molded on a first long side of the air guide hole, which bends or tilts toward an inner side of each of the arms from the first long side; the first long side of the air guide hole is a far side toward one of the arms on the same side of the main body.

6. The cooling system for the unmanned aerial vehicle, as recited in claim 4, wherein a length of each of the arms is equal or slightly longer than a single blade of the propellers.

7. An air guide structure for an unmanned aerial vehicle, comprising arms, propellers disposed on the arms, one or more air guide holes disposed on each of the arms; wherein the air guide holes on each of the arms are disposed near a main body and under an area formed by a tail of each of the propellers.

8. The air guide structure for the unmanned aerial vehicle, as recited in claim 7, wherein a guiding wall is integrally molded on one long side of the air guide hole, which guide an airstream to an internal of the main body.

9. The air guide structure for the unmanned aerial vehicle, as recited in claim 8, wherein the guiding wall is integrally molded on a first long side of the air guide hole, which bends or tilts toward an inner side of each of the arms from the first long side; the first long side of the air guide hole is a side first swept by each of the propellers.

10. The air guide structure for the unmanned aerial vehicle, as recited in claim 7, wherein three air guide holes are disposed on each of the arms; the air guide holes are distributed on an interval along a short side of each of the arms and on a top of a middle of the short side of each of the arms.

11. The air guide structure for the unmanned aerial vehicle, as recited in claim 10, wherein reinforce plates are disposed on an inner side of each of the arms, wherein the inner side faces wind.

12. The air guide structure for the unmanned aerial vehicle, as recited in claim 7, comprising the main body which connects the arms; wherein an airstream collected by the air guide hole is guided into the main body.

13. The air guide structure for the unmanned aerial vehicle, as recited in claim 12, wherein the main body and the arms are integrally molded; a top part of the main body indents a certain distance at a transitional connection part of the main body and the arms.

14. The air guide structure for the unmanned aerial vehicle, as recited in claim 12, wherein the airstream collected by the air guide hole enters the main body along an inner wall of the main body and circulates within a whole inner cavity of the main body.

15. A cooling air path system for an unmanned aerial vehicle, comprising an airstream source, air guide holes, an air path and an air vent; wherein the airstream source is generated by rotation of the propellers; the air guide holes are disposed on a top of each of arms and under an area formed by each of the propellers; the air path is space between an inner wall of a main body and an internal module inside the main body; the air vent is disposed on a bottom of the main body, which corresponds to a heat source area; an airstream is guided through the air guide holes to an inner side of each of the arms, enters the air path, passes the heat source area and is released through the air vent.

16. The cooling air path system for the unmanned aerial vehicle, as recited in claim 15, comprising a radiator which is disposed inside the main body and above the air vent; wherein the airstream passes the heat source area and the radiator in sequence before being released through the air vent.

17. The cooling air path system for the unmanned aerial vehicle, as recited in claim 16, wherein the internal module is a PCB (printed circuit board) module; electronic modules inside the unmanned aerial vehicle are mounted on the PCB module; the radiator is mounted on a back of the heat source area on the PCB module;

18. The cooling air path system for the unmanned aerial vehicle, as recited in claim 15, wherein the four arms are disposed on the main body, on which propellers are disposed; the diagonally distributed propellers rotates in a same direction; wherein the propellers on a left right arm and a right back arm are clockwise rotating propellers; the propellers on a right front arm and a left back arm are counterclockwise rotating propellers; the airstream generated by the rotation of the propellers sweeps to the arms and flows into the internal of the main body under the guidance of the air guide holes.

19. The cooling air path system for the unmanned aerial vehicle, as recited in claim 15, wherein the air guide holes are disposed on each of the arms; the air guide hole on each of the arms guides the air toward a middle of the main body; the airstream enters the main body, collides with the inner wall and the internal modules of the main body to form a fluctuating airflow.

20. The cooling air path system for the unmanned aerial vehicle, as recited in claim 19, wherein guiding walls are integrally molded on a long side of the air guide holes; the guiding walls of the air guide holes on each of the arms guide the air toward a same direction; the guiding walls of the air guide holes on the arms of a same side of the main body or diagonally opposite to each other are opposite, which guide the airstream to the internal of the main body.

21. The cooling air path system for the unmanned aerial vehicle, as recited in claim 15, wherein the main body comprises a top body shell, a bottom body shell and a bottom cover; wherein the air vent is disposed on the bottom cover; the top body shell and the bottom body shell are non-detachably connected; the bottom cover is detachable from the bottom body shell and forms a cavity with the air vent.
